(19) United States
(12) Patent Application Publication
(10) Pub. No.: US 2012/0148356 A1
(43) Pub. Date: Jun. 14, 2012

(54) Extrication Tool

(76) Inventor: Kevin F. Lohmeier, Roscoe, IL (US)

(21) Appl. No.: 13/313,750

(22) Filed: Dec. 7, 2011

Related U.S. Application Data
(60) Provisional application No. 61/421,005, filed on Dec. 8, 2010.

(51) Int. Cl. B23B 51/00; B21D 37/00

(52) U.S. Cl. 408/1 R; 408/219

(57) ABSTRACT

An extrication tool for enlarging openings or separating, spreading, or breaking apart materials, fastened to different structural geometry. The extrication tool generally includes a threaded conical shape with a wide aggressive thread with separate portions of the conical surface having different thread pitches, increasing from its tip end to its large distal end. In one form, an optional radial flange at the drive end restricts the device from penetrating into the materials acted upon.

### CROSS-REFERENCE TO RELATED APPLICATIONS

This application claims priority pursuant to Title 35 USC §119 to provisional application Ser. No. 61/421,005, filed Dec. 8, 2010, entitled “Extrication Tool.” The entire specification and drawings of that application are incorporated by reference herein as if fully set forth herein.

### BACKGROUND

The present invention relates generally to a tool for manipulating relatively rigid materials such as structural metal and more specifically it relates to an extrication tool for creating openings and/or separating, spreading, or breaking apart connected or fastened structural elements.

In the real word of emergency response, many different types of tools have their purpose to help to remove the victim of a collapsed structure or car accident. After an accident or collapse, the metal and other materials of the auto or structure are crushed and mangled. Therefore, the first responder picks the tool desired by that responder to do what needs to be done to reach a victim. This is called extrication.

The jaws of life is a prime example of such a tool used today. Others range from complex devices to more traditional tools such as crow bars and pry bars. Each accident provides its own challenges for removal of the victim to safety.

The device now to be explained does not exist in the world of extrication today and will provide a critical addition to the list of hundreds of tools used by a first responder to extricate the victim to safety.

There are many circumstances where the need exists for an opening for insertion of expansion tools such as shown in U.S. Pat. No. 7,107,812. Many opportunities are not taken advantage of because there is not enough room for the tool of choice because it is not possible to insert the operative jaws of the tool.

Therefore, the need exists for a device such as the disclosed here which creates a space between structural elements or surfaces to establish a purchase for an expansion tool. This new device screws into, and separates materials to create larger openings for other tools which may not be able to fit into an existing opening or seam. This tool will also provide a possible option to break two sections apart to permit removal of, for example, a jammed entry door to provide an access.

### SUMMARY

The invention generally relates to a rotatable tool of generally conical shape that includes a thread form extending from an entry tip to a large distal end. The tool is used for manipulating or displacing material to form a larger opening for insertion of another tool such as an expansion jaw device or pry bar. This tool includes a wide aggressive thread with a back taper on the rear flank of the thread to aggressively grasp the material to be separated or opening to be enlarged.

The tool may also include an optional radial flange at its large distal end spaced from the entry tip which restricts the device from penetrating too far into the material being separated or enlarged.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The benefits to be derived from an extrication tool for creating larger openings and separating, spreading, or breaking apart connected panels, includes separating crushed metal or materials to provide access areas for other tools during an extrication process, such as, in emergency situations involving vehicular accidents. The wide aggressive thread aids in gripping jagged materials. It also has a back taper design to draw into materials so as to counteract the geometric aspects of inserting a cone shaped device into the materials. It is expected that its configuration will screw into hinges of automobiles to aid in breaking of the hinge pin to allow for the removal of the vehicle doors. The optional radial flange at the larger end is to limit the device in its penetration into materials to keep the device from lodging in the material acted upon.

It is contemplated that the extrication tool of the present disclosure may comprise a set, or kit, of rotatable expansion devices as described of various sizes to provide a range of options for addressing material separation or expansion requirements of a given incident.

Other advantages of the present invention will become obvious to the reader and it is intended that these advantages are within the scope of the present invention. To the accomplishment of the above, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various features and attendant advantages of the present invention will become fully appreciated as the same becomes better understood when considered in conjunction with the accompanying drawings, in which like reference characters designate the same or similar parts throughout the several views, and wherein:

FIG. 1 is a side view, partially in section, of an embodiment of the extrication tool.

FIG. 2 is a fragmentary sectional view, on an enlarged scale, of the thread form of the extrication tool of FIG. 1.

FIG. 3 is a front view, from its entry tip end, of a modified form of extrication tool as shown in FIG. 1 with a radial back flange at its distal end.

FIG. 4 is a side sectional view of a modified form of an extrication tool of the present disclosure.

FIG. 5 is a fragmentary side sectional view of the extraction tool of FIG. 4.

FIG. 6 is a fragmentary view of a portion of the apparatus of FIG. 4.

FIG. 7 is a fragmentary view of a portion of the apparatus of FIG. 4.

FIG. 8 is a fragmentary view of a portion of the apparatus of FIG. 4.

### DETAILED DESCRIPTION

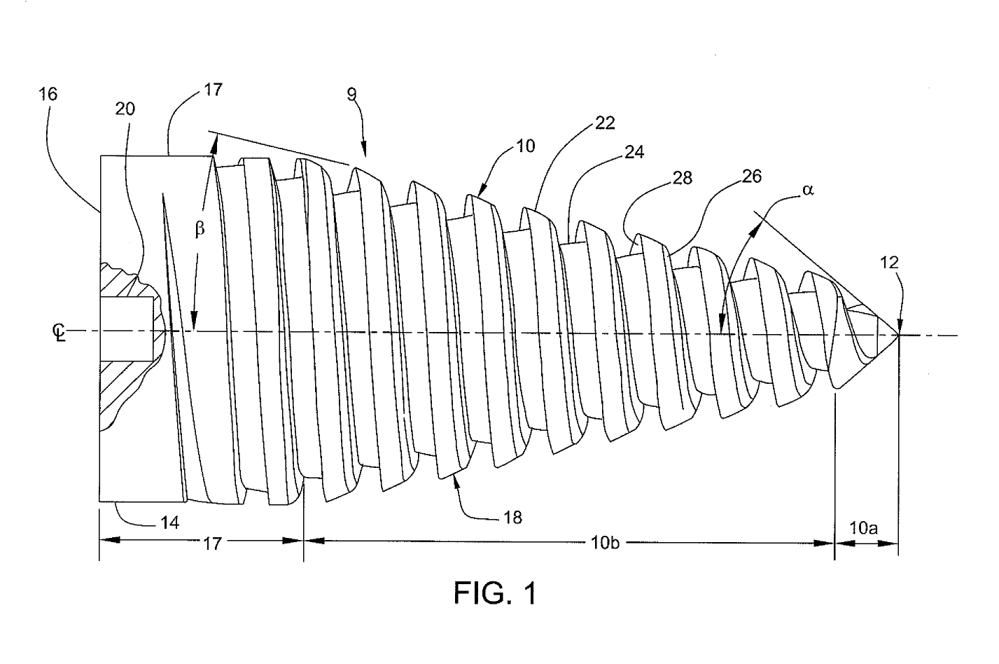

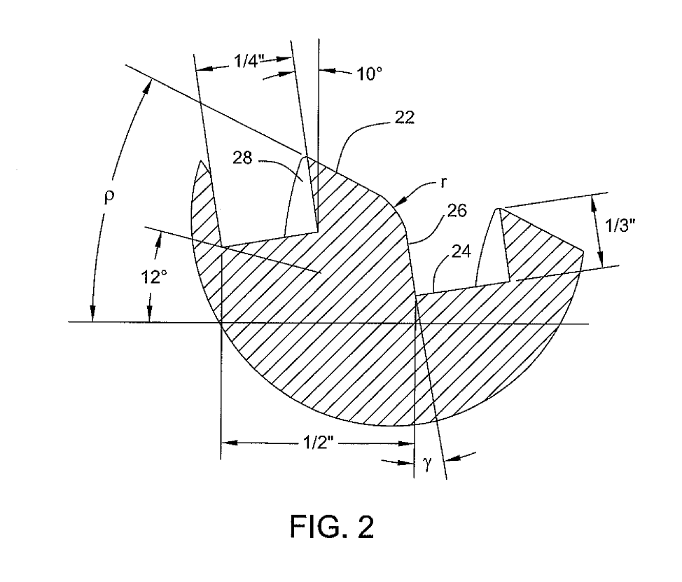

An embodiment of the extrication tool generally designated 9, is illustrated in FIGS. 1 and 2. It has a tapered conical body portion 10 that diverges from an entry tip end 12 toward a large distal end 14. An axial cylindrical portion 17 of the body extends from the tapered conical body portion 10 to a transverse rear wall 16 generally perpendicular to the longitudinal axis, CL.

As shown in FIGS. 1 and 2, the initial portion, 10a of the tapered conical body portion 10 is formed on a first conical angle (α) of about forty degrees (40°) to the longitudinal centerline or axis CL of the tool 9. The intermediate portion 10b of the tapered conical body portion 10 forms a second conical angle (β) of about twelve degrees (12°) to the longitudinal centerline CL. The included or “cone” angle of initial portion 10a is therefore eighty degrees (80°) and the included angle of the intermediate body portion 10b is twenty-four degrees (24°). These angles are of course illustrative and can be varied depending on contemplated usage of the tool 9.

A drive connection 20 in the form of a connection receptacle for an impact wrench or other tool is centered in rear transverse wall 16. The receptacle for connection to the device to rotate it about its longitudinal axis is sized to receive a one half inch (½″) or three quarter inch (¾″) socket extension or any desired connection configuration. The tool 9 may include an integral drive shaft extending rearward from rear wall 16 at distal end 14 for a connection to a power source such as a power tool such as an electric or pneumatic drill.

The device can be also made to be rotated by hand with a cross bar or socket wrench attached to the receptacle drive connection 20. The tool may be part of a hand implement with a cross bar (not shown) to manually rotate tool 9. It could the working tip, for example, of to long or short crowbar or pry bar (not shown) or could include an attachable “T” handle. It can be configured to be manually driven into an opening to penetrate the desired point of entry. Once the device is screwed into the material to the desired distance the tool now becomes a functional crowbar. If desired, the bar can be removed if desired, provides a driving force which can be actuated by hand from the first responder. Manual use can be very important if there is a power outage for example.

The above are illustrative suggestions. The tool may be used in enumerable penetrations or drive configurations. These methods of driving the tool are not limiting, and many other ways that may be employed to drive the tool.

Referring to FIGS. 1 and 2, the outer conical surface of the conical body portion 10 is provided with an aggressive thread 18 best shown in cross sectional view in FIG. 2. The thread commences at the entry tip end 12 and progresses rearward along the tapered conical body portion in the embodiment of FIG. 1 and extends onto, and terminates on axial cylindrical portion 17. The length of initial portion 10a is about equal to the thread pitch. In this illustrated embodiment a single pitch thread is shown, but is only illustrative, and not limiting.

The thread illustrated in FIGS. 1 and 2 is a “square thread” with axially extending helical crests 22 and roots 24 connected by leading flank surface 26 and trailing flank surface 28. The crests 22 merge with leading flank surfaces 26 by a radius r shown in FIG. 2.

As seen in FIG. 2, the back surface or trailing flank 28 of the thread form is angled back toward the rear transverse wall 16 at an angle (γ). The leading flank 26 is parallel to the trailing flank 28. The root surface 24 of the aggressive thread is ninety degrees (90°) to the flank angle, that is, ninety degrees (90°) to the flank surfaces 26 and 28.

As illustrated in FIG. 2, the thread flanks 26 and 28 have back angle (γ) of ten degree (10°) back taper to a radial plane perpendicular to the axial centerline CL of the tool 9. It is felt that such a back angle or “rake” maximizes the ability of the tool to grip and drive into the material acted upon when rotated. This angle could however be larger, or smaller, or even eliminated, depending on anticipated need.

The tool 9 illustrated in FIGS. 1 and 2 has a diameter of three and three quarter inches (3¾″) at axial cylindrical portion 17 and an overall length of eight and one half inches (8½″). The thread pitch of the single pitch thread is one half inch (½″). Cylindrical portion 17 is two inches (2″) long. These dimensions can of course be varied and are exemplary.

The length of each crest 22 and root 24 between leading flank surface 26 and trailing flank surface 28 is about one quarter inch (¼″). The length of each trailing flank surface 28 from root 24 to crest 22 is about one third inch (⅓″).

As seen in FIG. 2, the crest 22 of the thread 18 is formed at an angle (ρ) to the longitudinal centerline CL of tool 9 which is greater than the angle (β) of the intermediate portion of tapered conical body portion 10b. Here it is illustrated as twenty-five degrees (25°). This form puts the leading edge of crest 22 at leading flank surface 24 somewhat closer to the centerline CL than it would be if crest 22 followed the same angle as the angle β of conical body portion 10b. Since the rear (divergent end) of the thread angle is higher (further from centerline CL) than the front (nearer the entry tip end), it allows for easier forward movement and makes it harder to come out of materials or group of materials. It is thought that this configuration allows the tool to be forced into a material or group of materials easier and harder to pull out.

The described angles can be any desired angle which may be required to do a specific job. The initial portion 10a of tapered conical body portion 10 has an angle (α) of forty degrees (40°) but is not limiting and is illustrative only. The wider angle at initial portion 10a provides for a more substantial cross section of the tool near entry tip end 12 than would be the case if the body portion 10 tapered uniformly at angle (β), illustrated in FIGS. 1 and 2 as twelve degrees (12°). The initial portion 10a thereby has more strength, and is less likely to break during insertion and rotation to penetrate, and separate or expand materials as illustrated in FIG. 10.

The dimensions can of course vary and the tool could be bigger or smaller. For example, for more rugged applications, it is contemplated that a tool 9 could be made having a diameter at axial cylindrical portion 17 of six inches (6″) or more and a length between entry tip end 12 and rear transverse wall 16 of twelve inches (12″) or more. The pitch contemplated could be one inch (1″) and the thread width between leading flank surface 26 and trailing flank surface 28 would be one half inch (½″). The thread depth (length of leading flank surface 26 or trailing flank surface 26) would increase proportionately.

It is also contemplated that the cone angle of the intermediate portion 10b of conical body portion 10 and the angle of initial portion 10a can be varied depending on contemplated need. If the cone angle of tapered conical body portion 10 is increased, the overall length of tool 9 is shortened resulting in a more robust configuration of tool 9. A cone angle (β) relative to longitudinal centerline CL of intermediate conical portion 10b could, for example, be sixteen degrees (16°). Slightly different dimensions for aggressive thread 18 are also contemplated without departing from the scope of the disclosure.

As another example, the extrication tool 10 could be three inches (3″) in diameter at axial cylindrical surface 17 and twelve inches (12″) in length from entry tip end 12 to rear transverse wall 16. Such a tool provides a more gradual transition along the threaded conical body portion 10. It is contemplated that such a configuration would increase the tool's ability to screw into an opening to force apart the materials acted upon more gradually as the tool advances.

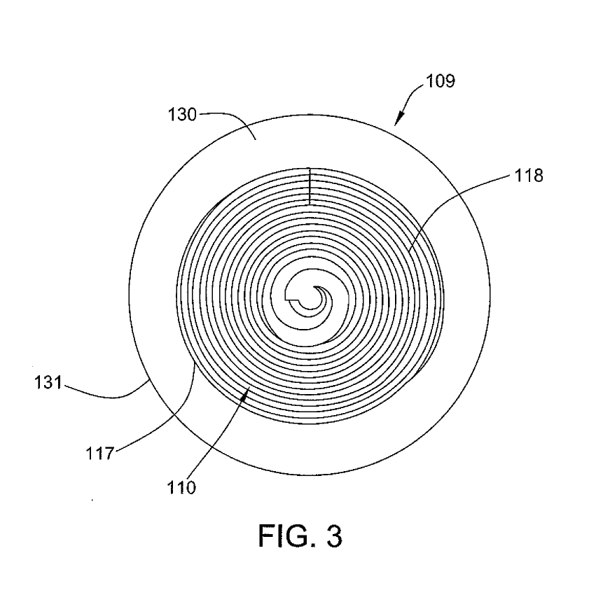

FIGS. 1 and 2 illustrate an extrication tool with a wide aggressive thread and back taper on the flanks of the thread. The optional back flange illustrated in FIG. 3 and described below, is not necessary to the performance of the device in penetration, spreading or separating material. It does, however, prevent it from lodging in the material acted upon as explained in detail below.

The conical shape of extrication tool 9 allows the device to start in a small seam or other access point or create its own access, by penetration of its sharp or semi-sharp point and to progress to a larger diameter opening to separate materials such as adjacent automotive body panels or an automotive door hinge. On rotation of the tool, the threads 18 engage the edges of the panels and the tool is driven between the panels. The panels are deformed or moved apart as the tool advances to create an opening suitable to receive another tool such as the jaws of life for further separation.

As in an example of a hinge pin in many but not all automotive doors, this device with its aggressive thread width would allow the hinge pin to fit into the thread slot between a leading flank surface 26 and trailing flank surface 28 as it was being rotated or screwed into the area of the hinge pin, pushing the two opposing sides apart as desired.

The aggressive thread is much wider than the typical fastener. That is, it has a thread design allowing for the device to grip, hold or fasten to surfaces of infinite shapes or configurations for example a jagged crushed car body during an accident. It also is required to allow for larger hinge pins to fall between and into the thread to better grip and hold while being used as an example to separate the door from the body of a vehicle.

The function of the back taper is to help to draw the device into materials and to counteract the natural forces that a geometrical shape of a cone tends to the force the tool out of the material. This configuration allows the device to grip and hold onto different shapes and fit into small crevices and spread them apart to create a larger opening or break the material or materials apart.

The back taper designated as angle (γ) in FIG. 2 is a feature of the embodiment of FIGS. 1 and 2. Illustrated in FIGS. 1 and 2 as ten degrees (10°) to a plane perpendicular to the longitudinal axis CL of the tool, this back taper can be of different angles. It is there to insure to draw into, and hold onto materials. It also is a geometric alteration to counteract the geometric shape of a cone which tends, as it is advanced, to naturally be forced out of a material because of its cone shape geometry. The back taper can be in any desired angle to fit the required need or could be eliminated.

The functional variations of the tool can also be changed by altering the outer diameter of cylindrical portion 17 and cone angle of intermediate body portion 10b to fit a particular need. The larger the cone angle β of the body portion 10, the more robust the tool body. The conical shape can be in any desired size and taper, depending on need. The conical geometric shape starts at a point or semi-point and diverges to a larger diameter to provide a wedging effect on the materials as it enters the seam or starter hole in a panel.

In use, the tool 9 is attached to a driving force for example an impact wrench or any manual tool desired to drive the tool. In the example of an extrication by first responders the tool could be inserted into a small opening between panels or be forced to create its own opening by penetrating the surface of the materials acted upon. Once the device has gripped enough because of the aggressive thread design and back taper, the tool will draw into the materials and separate them to the desired distance and/or break them apart as desired. Once the opening is made, other tools, for example the jaws of life, can be inserted into the enlarged opening.

Numerous options are contemplated for the tool of the present disclosure. For example, tool 9 of FIGS. 1 and 2 could be made with a replaceable tip. Rather than including a thread commencing at tip end 12, for example, the tip of tool 9 at initial portion 10a could be unthreaded, and pointed to penetrate the material to be acted upon. It would be useful to pierce a starting hole in a metal panel and also for insertion between tightly spaced, but separate, panels.

Referring now to FIG. 3, tool 109 similar to tool 9 of FIGS. 1 and 2 includes a conical body portion 110 with aggressive back taper threads 118. In this embodiment, tool 109 is provided with a large radial flange 130 extending radially outwardly from axial cylindrical portion 117 at distal end. Flange 130 extends about the perimeter of the axial cylindrical portion 117 and provides a stop for the threads 118 of tapered conical body portion 110 and helps to keep the device from being rotated too far into the material acted upon. If the device were driven too far into the material it may be very difficult to remove in many situations. Therefore, outer flange 130 is important to restrict the device from total penetration into the materials. It is an option, however, to the basic tool 9 of FIGS. 1 and 2. It is contemplated that for a tool such as tool 9, the length of the flange, from axial cylindrical surface 117 to its outer perimeter 131 is about one inch (1″), though it could be longer or shorter.

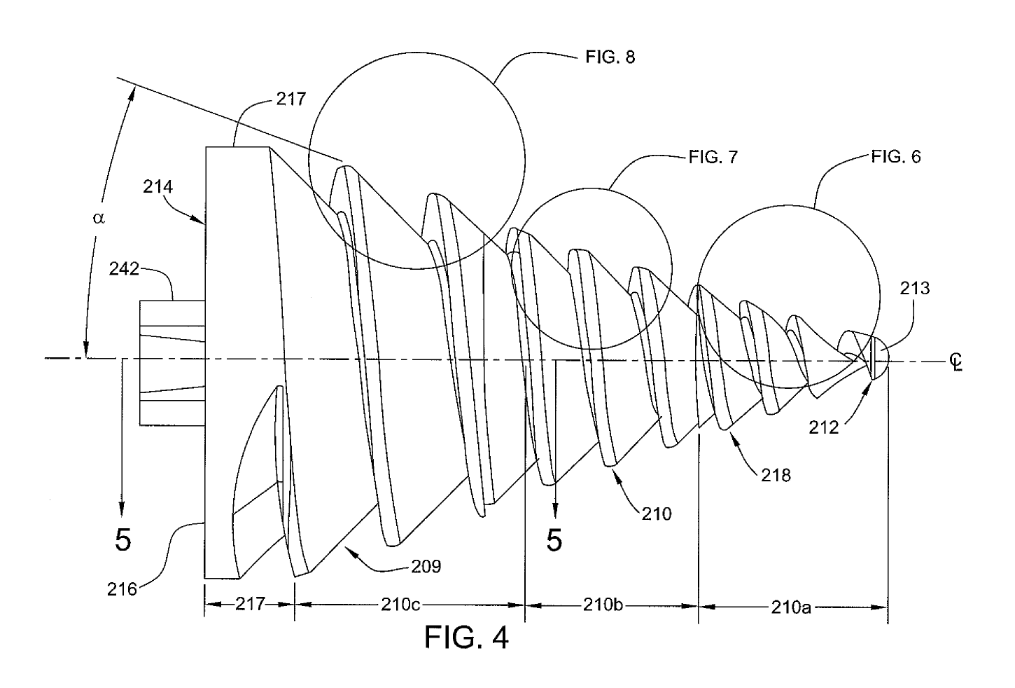

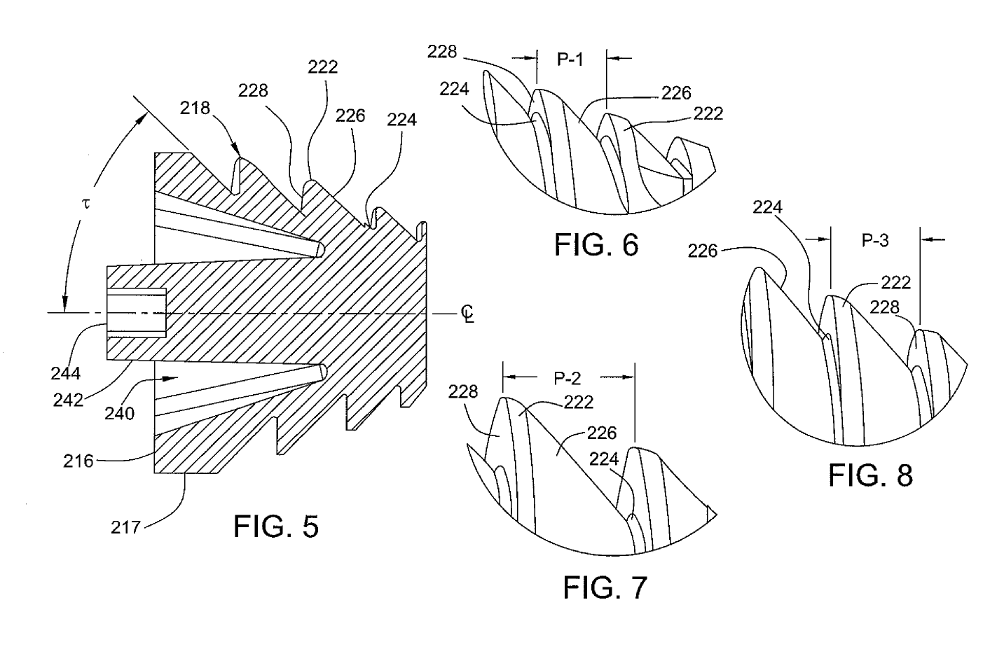

FIGS. 4 and 5 illustrate an embodiment of a tool 209 similar to tool 9 of FIGS. 1 and 2, with a tapered conical body portion 210 with another faint of aggressive thread 218 effective to accomplish the purposes of this disclosure as already described.

FIGS. 4 and 5 illustrate a modified form of conical body for an extrication tool. Here extrication tool 209 with a tapered conical body portion 210 having an aggressive thread form 218 is formed by milling, casting or forging. It defines void space 240 seen in FIG. 5 to reduce the overall weight. An integral central shaft 242 extends from void space 240 and terminates in an end arranged with a hex nut drive receptacle 244. The drive connection in the form of connection receptacle 244 for an impact wrench or other tool is centered relative to tapered conical body portion 210.

The receptacle for connection to the device to rotate it about its longitudinal axis CL is sized to receive, for example, a one half inch (½″) or three quarter inch (¾″) socket extension or any desired connection configuration. Another option would include elimination of central shaft 242 to increase the void space and decrease weight. A socket receptacle to receive a socket extension or other drive connection would be provided centrally of void space 240 at the forward end of the void space, toward the conical tip end.

Tapered conical body portion 210 diverges from an entry tip end 212 toward a large distal end 214. An axial cylindrical portion 217 of the body extends from the tapered conical body portion 210 to a transverse rear annular wall 216 generally perpendicular to the longitudinal axis, CL. In this embodiment, tip end 212 includes a rounded nose 213.

In this embodiment, the threaded body portion 210 is divided into three portions. Commencing at tip end 212, it includes an initial pitch portion 210a, and intermediate pitch portion 210h, and a large end pitch portion 210c, as illustrated in FIG. 4. The initial pitch portion, 10a of the tapered conical body portion 10 is formed with a first thread pitch P-1 seen in FIG. 6. The intermediate pitch portion 210b is formed with a second thread pitch P-2 seen in FIG. 7 and the large end pitch portion 210c is formed with a third thread pitch P-3 seen in FIG. 8. The pitch (P-2) of the intermediate pitch portion 210b is larger than the pitch (P-1) of the initial pitch portion 210a. The pitch (P-3) of the large end pitch portion 210c is larger than the pitch of the intermediate pitch 210b. As an example, in a tool 209, having a diameter at axial cylindrical portion 217 of about three inches, the pitch P-1 is 0.391 inches, the pitch P-2 is 0.500 inches and the pitch P-3 is 0.750 inches. Thus, as the tool 209 advances into a hole or gap between adjacent panels, it advances further with a single revolution. This configuration minimizes the time required to produce a hole or space sufficient to receive another implement such as the operating jaws of metal expander or similar extrication device and provides increasingly aggressive contact and grabbing effect to aid in the force needed to continue screwing the tool in place.

The conical angle (α) of the conical body portion 210 is formed at an angle generally consistent from its tip end 212, to the merger with axial cylindrical body portion 217, though it may vary somewhat between the initial pitch portion 210(a), intermediate pitch portion 210(b) and large end pitch portion 210(c). In the embodiment illustrated in FIGS. 4 to 8, the angle (α) is between fourteen degrees (14°) and eighteen degrees (18°) relative to the axis CL. Thus, the included angle of the tapered conical portion 210 is between twenty-eight degrees (28°) and thirty-six degrees (36°).

Notably, it is expected that a conical body portion 212 having different angles for each conical portion, or the same angle for each conical portion are within the scope of the disclosure.

The outer conical surface of the tapered conical body portion 210 is provided with an aggressive thread 218 best shown in cross sectional view in FIG. 5, and in FIGS. 6, 7, and 8. The thread commences at the entry tip end 12 and progresses rearward along the tapered conical body portion and extends onto, and terminates on axial cylindrical portion 217.

The thread of the embodiment of FIGS. 4 to 8 includes axially extending helical crests 222, roots 224, leading flank surfaces 226 and trailing flank surfaces 228. Crests 222 are formed at an angle relative to axis CL consistent with the cone angle of the tapered conical body portion 210. That is, the angle of the crest surface 222 follows the cone angle of the body portion where the thread is extant.

As seen in FIG. 5, the trailing flank surfaces 228 of the thread form are formed at an angle (γ) of zero degrees. That is, the surfaces 228 are perpendicular to the axis CL. As disclosed with respect to the embodiment of FIGS. 1 to 3, it may be desirable, in certain applications, to employ an angle (γ) back toward annular transverse wall 216. Such a configuration is not essential in this embodiment.

As illustrated in the embodiments of FIGS. 4 to 8, the leading flank surfaces 226 extend between root surface 224 and crest surface 222 at an angle (τ) of forty-five degrees (45°) to the axis CL. Note that the crest surfaces 222 have a larger axial length than do root surfaces 224. In the previously described example of a structure embodying thread configuration shown in FIGS. 4 to 8, the crest surfaces 222 in thread portions P-1, P-2 and P-3 have an axial length of 0.104 inches.

It should be noted that the illustrated embodiments include three thread portions with three different thread pitches (axial pitch). The number of such separate conical thread portions with different threat pitches is not limited to three. An effective tool, for example, could include two such separate thread portions, or even four such separate thread portions without departing from the disclosure. It is important to note that the axial pitch length of each separate thread portion increases as the diameter of the cone increases, from the entry tip end 212 toward the axial cylindrical portion 217. This configuration is helpful to the performance of the tool in an extrication operation.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in the broadest, reasonable sense unless otherwise indicated. Any headings utilized within the description are for convenience only and have no legal or limiting effect.

1. An extrication tool comprising a generally conical body diverging from a tip end toward a large distal end and having a thread formed on its exterior conical surface, said thread including at least a first pitch portion adjacent its tip end, and a second pitch portion spaced toward said large distal end from said first pitch portion.

2. An extrication tool as claimed in claim 2 wherein the pitch of said threads in said first pitch portion is different compared to the pitch of said threads in said second pitch portion.

3. An extrication tool as claimed in claim 3 wherein the pitch of said threads in said second pitch portion is larger than the pitch of said threads in said first pitch portion.

4. An extrication tool as claimed in claim 3 wherein said body further includes a third pitch portion spaced from said second pitch portion toward said large distal end.

5. An extrication tool as claimed in claim 4 wherein said pitch of said threads in said third pitch portion is larger than the pitch of said threads in said second pitch portion.

6. An extrication tool as claimed in claim 1 wherein said tool defines a hollow void extending from said large distal end toward said tip end.

7. An extrication tool as claimed in claim 2 wherein said tool defines a hollow void extending from said large distal end toward said tip end.

8. An extrication tool as claimed in claim 3 wherein said tool defines a hollow void extending from said large distal end toward said tip end.

9. An extrication tool as claimed in claim 4 wherein said tool defines a hollow void extending from said large distal end toward said tip end.

10. An extrication tool as claimed in claim 5 wherein said tool defines a hollow void extending from said large distal end toward said tip end.

11. An extrication tool as claimed in claim 1 wherein said tool includes a drive receptacle at its large distal end.

12. An extrication tool as claimed in claim 3 wherein said tool includes a drive receptacle at its large distal end.

13. An extrication tool as claimed in claim 5 wherein said tool includes a drive receptacle at its large distal end.

14. An extrication tool as claimed in claim 6 wherein said tool includes a drive receptacle at its large distal end.

15. An extrication tool as claimed in claim 8 wherein said tool includes a drive receptacle at its large distal end.

16. An extrication tool as claimed in claim 10 wherein said tool includes a drive receptacle at its large distal end.

17. An extrication tool as claimed in claim 16 wherein said tool includes an annular radial flange extending outwardly adjacent said large distal end.

18. An extrication tool comprising a generally conical body diverging from a tip end toward a drive end and having a thread formed on its exterior conical surface, said thread including crest surfaces and root surfaces, joined by a trailing flank surface and a leading flank surface, said flank surfaces being parallel to each other and said root surface being perpendicular to said trailing and leading flank surfaces.

19. An extrication tool as claimed in claim 18 wherein said crest surfaces are formed at an angle relative to the axis of said tool different than the angle of said conical body relative to the axis of said tool.

20. An extraction tool as claimed in claim 19 wherein said trailing flank surface is formed at a back rake angle of about 10° relative to a radial plane perpendicular to the axis of said tool.

21. A method of creating an opening in rigid structural elements utilizing an extrication tool comprising:
a generally conical body diverging from a tip end toward a large distal end and having a thread formed on its exterior conical surface, said thread including a first pitch portion adjacent its tip end, a second pitch portion spaced toward said large distal end from said first pitch portion, and a third pitch portion spaced from said second pitch portion toward said large distal end;
wherein the pitch of said threads in said second pitch portion is larger than the pitch of said threads in said first pitch portion; and
wherein said pitch of said threads in said third pitch portion is larger than the pitch of said threads in said second pitch portion;
the steps comprising:
rotating said tool to insert said tool into said structural element and create an opening therein as said tool advances.
